(19) United States
(12) Patent Application Publication
(10) Pub. No.: US 2014/0329536 A1
(43) Pub. Date: Nov. 6, 2014

(54) SYNTHETIC WIDEBAND RANGING DESIGN

(71) Applicant: QUALCOMM INCORPORATED, San Diego, CA (US)

(72) Inventors: Bin TIAN, San Diego, CA (US); Ahmad JALALI, Rancho Santa Fe, CA (US)

(73) Assignee: QUALCOMM Incorporated, San Diego, CA (US)

(21) Appl. No.: 13/874,701

(22) Filed: May 1, 2013

(51) Int. Cl. H04W 64/00

(52) U.S. Cl. CPC H04W 64/00
USPC 455/456.1

(57) ABSTRACT

A method includes sequentially transmitting a ranging signal a predetermined number of times in different frequency bands to form a wideband ranging signal. The method further includes receiving a range estimate based at least in part on the wideband ranging signal.

### FIELD

Aspects of the present disclosure relate generally to wireless communication systems, and more particularly to a position location architecture.

### BACKGROUND

Wireless networks are widely deployed to provide various communication services such as voice, video, packet data, messaging, broadcasting and other like wireless communication services. These wireless networks may be multiple-access networks capable of supporting multiple users by sharing the available network resources. In a wireless local area network (WLAN), an access point (AP) supports communication for a number of wireless stations within the wireless network. In an ad-hoc mode, the wireless stations (“peer nodes”) communicate in a peer-to-peer (P2P) manner without an AP. Similarly, a peer-to-peer network allows the peer nodes to directly communicate with one another. In a peer-to-peer network, peer-to-peer nodes within range of one another discover and communicate directly without an AP.

An indoor positioning system (IPS) may refer to a network of devices used to wirelessly locate objects or people inside a building. Instead of using a satellite positioning system (SPS), an IPS may rely on nearby nodes that actively locate tags.

### SUMMARY

A method of wireless communication within a position location system in accordance with an aspect of the present disclosure includes sequentially transmitting a ranging signal a predetermined number of times in different frequency bands to form a wideband ranging signal. The method further includes receiving a range estimate based at least in part on the wideband ranging signal.

A method of wireless communication within a position location system in accordance with an aspect of the present disclosure includes storing samples from sequentially received signals. Each signal is received in a different frequency band. The method further includes jointly processing the samples to form a single waveform. The method also includes estimating a range from the single waveform according to a predetermined ranging operation.

A position location system in accordance with an aspect of the present disclosure includes a transmitter for sequentially transmitting a ranging signal a predetermined number of times in different frequency bands to form a wideband ranging signal. Such a system also includes a receiver for receiving a range estimate based at least in part on the wideband ranging signal.

A position location system in accordance with another aspect of the present disclosure includes means for sequentially transmitting a ranging signal a predetermined number of times in different frequency bands to form a wideband ranging signal. Such a system further includes means for receiving a range estimate based at least in part on the wideband ranging signal.

A computer program product configured for wireless communication within a position location system in accordance with an aspect of the present disclosure includes a non-transitory computer-readable medium having non-transitory program code recorded thereon. The non-transitory program code includes program code to sequentially transmit a ranging signal a predetermined number of times in different frequency bands to form a wideband ranging signal. The non-transitory program code also includes program code to receive a range estimate based at least in part on the wideband ranging signal.

A position location system in accordance with another aspect of the present disclosure includes means for storing samples from sequentially received signals, each signal being received in a different frequency band. Such a system further includes means for jointly processing the samples to form a single waveform. Such a system further includes means for estimating a range from the single waveform according to a predetermined ranging operation.

A computer program product configured for wireless communication within an position location system in accordance with another aspect of the present disclosure includes a non-transitory computer-readable medium having non-transitory program code recorded thereon. The non-transitory program code includes program code to store samples from sequentially received signals, each signal being received in a different frequency band. The non-transitory program code further includes program code to jointly process the samples to form a single waveform. The non-transitory program code further includes program code to estimate a range from the single waveform according to a predetermined ranging operation.

A position location system in accordance with another aspect of the present disclosure includes a memory that stores samples from sequentially received signals, each signal being received in a different frequency band. Such a system further includes a processor that jointly processes the samples to form a single waveform. Such a system further includes an estimator that estimates a range from the single waveform according to a predetermined ranging operation.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates a diagram of a communication system according to one aspect of the disclosure.

FIG. 2 is a block diagram illustrating an exemplary hardware configuration of wireless nodes used in the communication system, such as the position location system illustrated in FIG. 4.

FIG. 3 illustrates a diagram of a peer-to-peer network according to one aspect of the disclosure.

FIG. 4 is a diagram illustrating a position location system according to one aspect of the disclosure.

FIG. 5 is a flow chart illustrating a position location method implemented in the position location system illustrated in FIG. 4 according to one aspect of the disclosure.

FIG. 6 is a flow chart illustrating a position location method implemented in the communication system illustrated in FIG. 4 according to one aspect of the disclosure.

FIG. 7 is a block diagram illustrating a signaling diagram in accordance with one aspect of the present disclosure.

FIGS. 8 and 9 are flow charts illustrating methods in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

In one aspect of the disclosure, a position location system, which may be an indoor position location system, tracks the location of assets (e.g., users) using a device that that may be worn by an asset, referred to herein as an “asset tag.” The asset tag may support wireless node functionality (e.g., a wireless station and/or a wireless node of a peer-to-peer network), or other like radio access technology. It should be recognized that asset tag operation to enable the position location system may be incorporated into a wireless handheld device of a user. Although the asset tags may be specified as stations, aspects of the disclosure also relate to ad-hoc and/or peer-to-peer network implementations in which wireless peer nodes and/or wireless stations discover and communicate directly without APs. A wireless station can be a dedicated access point or a temporary access point (e.g., a soft AP) configured for access point functionality, for example, when operating according to a wireless local area network (WLAN) infrastructure mode. In a WLAN ad-hoc mode, or peer-to-peer network, the wireless stations/peer nodes discover and communicate directly without an AP.

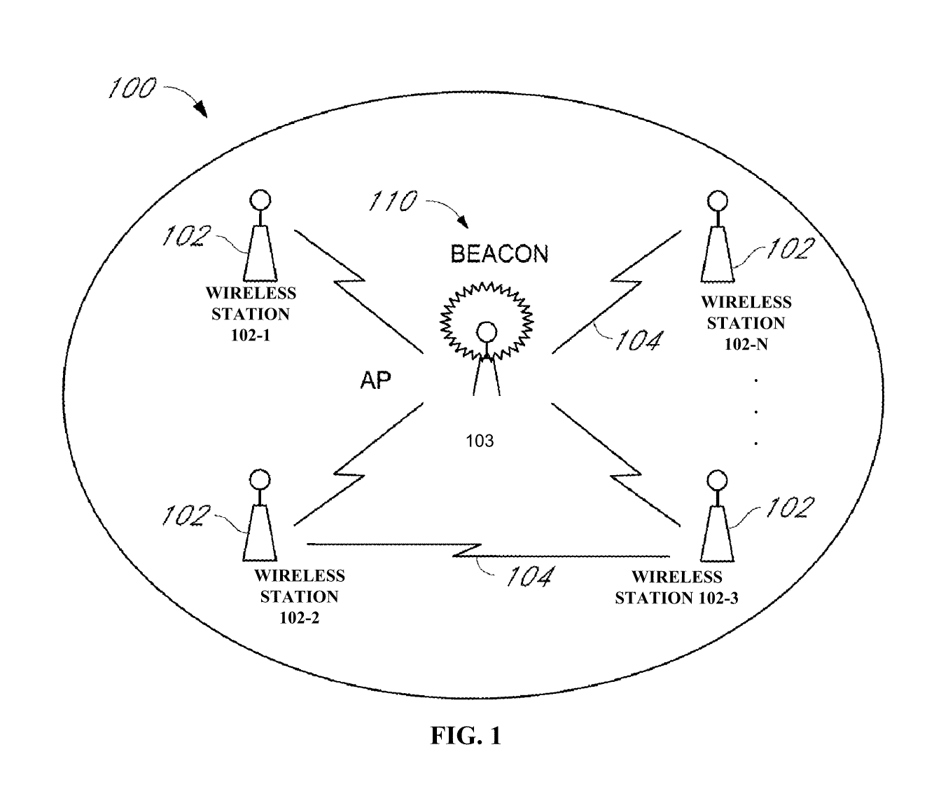

In one aspect of the disclosure, the asset tags transmit known preambles that are received by multiple APs. The APs may estimate and send a time of arrival (TOA) of the preamble from a specific asset tag to a position location server. The position location server processes received TOAs from the multiple APs to estimate the position of the asset tags. In another configuration, the APs transmit a known beacon signal that is received by all asset tags in the respective coverage area of the APs. In this configuration, the asset tags make time difference of arrival (TDOA) measurements from the received beacon signals from different APs. The asset tags may compute their position based on the TDOA measurements or send the TDOA measurements to a position location server (PLS) for position location computation. The position location system may be implemented in various wireless networks, such as the WLAN configuration shown in FIG. 1.

System Overview

One example of a wireless communication system 100 is illustrated in FIG. 1. The wireless communication system 100 may include a number of wireless stations 102 (102-1 . . . 102-N) and APs 103 that can communicate with one another over wireless links 104. Although the wireless communication system 100 is illustrated with five wireless stations/APs 102/103, it should be appreciated that any number of stations and APs (wired or wireless) may form the wireless communication system 100. In the illustration, the APs 103 are dedicated APs. Alternatively, the APs 103 may be configured for access point functionality (e.g., as a soft AP).

The wireless stations/APs 102/103 may be any device configured to send and receive wireless communications, such as a laptop computer, smartphone, a printer, a personal digital assistant, a camera, a cordless telephone, a session initiation protocol phone, a handheld device having wireless connection capability, a user equipment, an access terminal, or any other suitable device. In one aspect of the disclosure, the wireless stations/APs 102/103 are incorporated into a tag placed on an asset (e.g., a user). In the wireless communication system 100, the wireless stations/APs 102/103 may be distributed throughout a geographic region. Further, each wireless station/access point 102/103 may have a different coverage region over which it may communicate. The APs 103 may include or be implemented as a base station, a base transceiver station, a terminal, a wireless node operating as an AP, or the like. The wireless stations/APs 102/103 in the wireless communication system 100 may communicate wirelessly using any suitable wireless network standard.

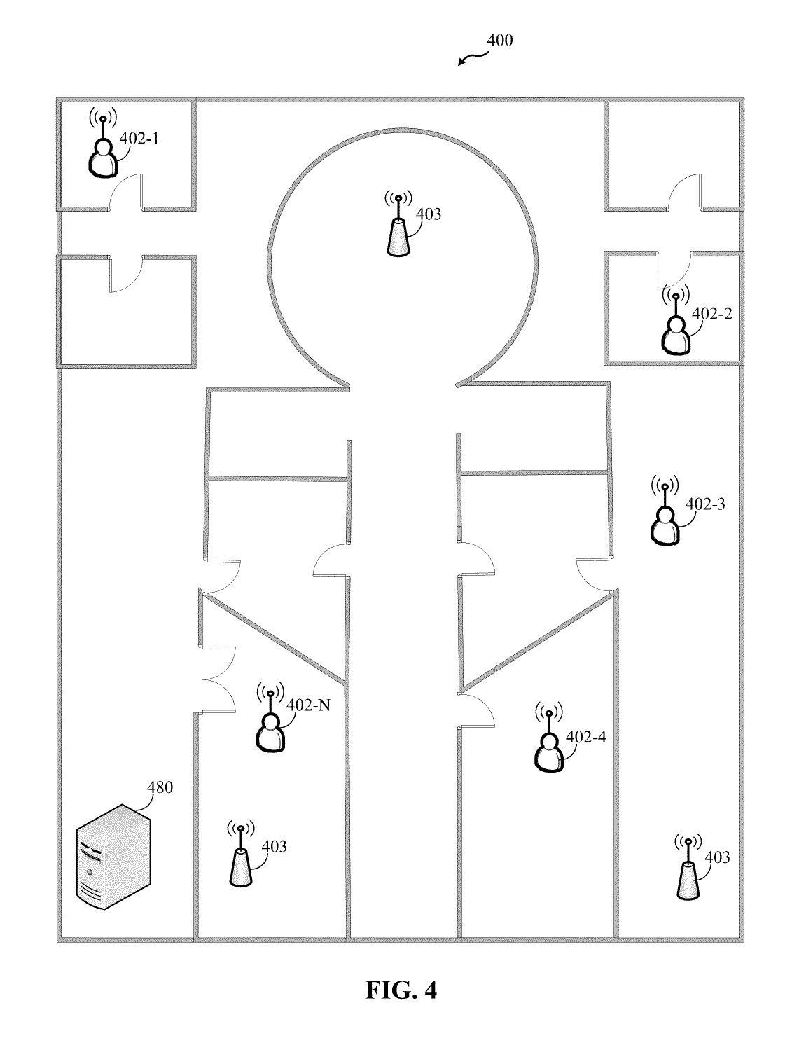

In one configuration, an asset tag may be configured as one of the wireless stations 102 that associates with one of the APs 103 to send and/or receive position information from one of the APs 103 according to an initial wireless access message 110 (e.g., beacon) broadcast by one of the APs 103. In one aspect of the disclosure, the asset tags measure beacon signals from APs 103 and compute an asset tag position. Alternatively, the asset tags transmit the beacon measurements to a position location server. In another configuration, the asset tags transmit known preambles that are received by the APs 103. The APs 103 may estimate and send the time of arrival (TOA) of the preamble from a specific tag to the position location server that estimates the position of the asset tags. Position location computations may be carried out at the position location server using the TOAs and/or TDOAs received from the different APs 103, for example, as shown in FIG. 4.

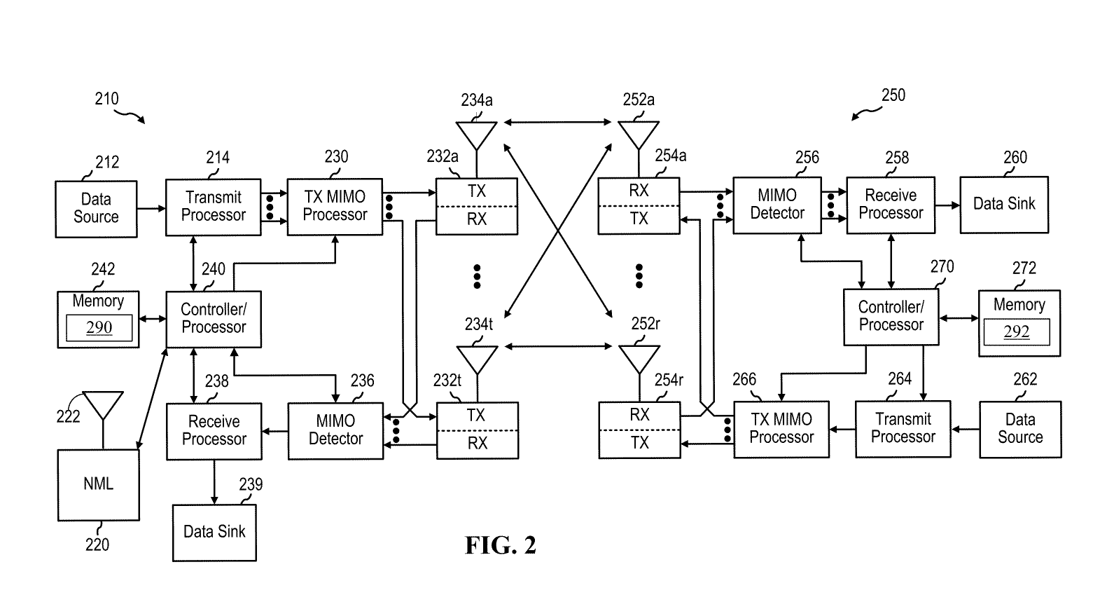

FIG. 2 shows a block diagram of a design of an access point 210 and a wireless station 250, each of which may be one of the wireless nodes in FIGS. 1, 3, and 4. Each of the wireless nodes in the wireless communication system 100 may include a wireless transceiver to support wireless communication and controller functionality to manage communication over the network. The controller functionality may be implemented within one or more digital processing devices. The wireless transceiver may be coupled to one or more antennas to facilitate the transmission and reception of signals over a wireless channel.

In one configuration, the access point 210 may be equipped with antennas 234 (234a, . . . , 234t), and the wireless station 250 may be equipped with antennas 252 (252a, . . . , 252r).

At the access point 210, a transmit processor 214 may receive data from a data source 212 and control information from a controller/processor 240. The transmit processor 214 may process (e.g., encode and symbol map) the data and control information to obtain data symbols and control symbols, respectively. The transmit processor 214 may also generate reference symbols, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the transceivers 232 (232a, . . . , 232t). Each of the transceivers 232 may process a respective output symbol stream to obtain an output sample stream. Each of the transceivers 232 may further process (e.g., convert to analog, amplify, filter, and upconvert) the output sample stream to obtain a transmission signal. Signals from transceivers 232 may be transmitted via the antennas 234 (234a, . . . , 234t), respectively.

At the wireless station 250, the antennas 252 (252a, . . . , 252r) may receive the signals from the access point 210 and may provide received signals to the transceivers 254 (254a, . . . , 254r), respectively. Each of the transceivers 254 may condition (e.g., filter, amplify, downconvert, and digitize) a respective received signal to obtain input samples. Each of the transceivers 254 may further process the input samples to obtain received symbols. A MIMO detector 256 may obtain received symbols from all of the transceivers 254, perform MIMO detection on the received symbols if applicable, and provide detected symbols. A receive processor 258 may process (e.g., demodulate, deinterleave, and decode) the detected symbols, provide decoded data for the wireless station 250 to a data sink 260, and provide decoded control information to a controller/processor 270.

When transmitting, from the wireless station 250, a transmit processor 264 may receive and process data from a data source 262 and control information from the controller/processor 270. The transmit processor 264 may also generate reference symbols for a reference signal. The symbols from the transmit processor 264 may be precoded by a TX MIMO processor 266 if applicable, further processed by the transceivers 254, and transmitted to the access point 210. At the access point 210, the signals received from the wireless station 250 may be received by the antennas 234, processed by the transceivers 232, detected by a MIMO detector 236 if applicable, and further processed by a receive processor 238 to obtain decoded data and control information sent by the wireless station 250. The receive processor 238 may provide the decoded data to a data sink 239 and the decoded control information to the controller/processor 240. The access point 210 can send messages to other base stations, for example, over a backhaul link. In one configuration, the access point includes a narrowband messaging link (NML) 220 having an antenna 222 for enabling synchronization and ranging initialization between asset tags and APs of a position location system, for example, as shown in FIG. 4. It should be recognized that the wireless station 250 may also be configured to include a narrowband message link, such as the NML 220 of the access point 210, although it is not shown.

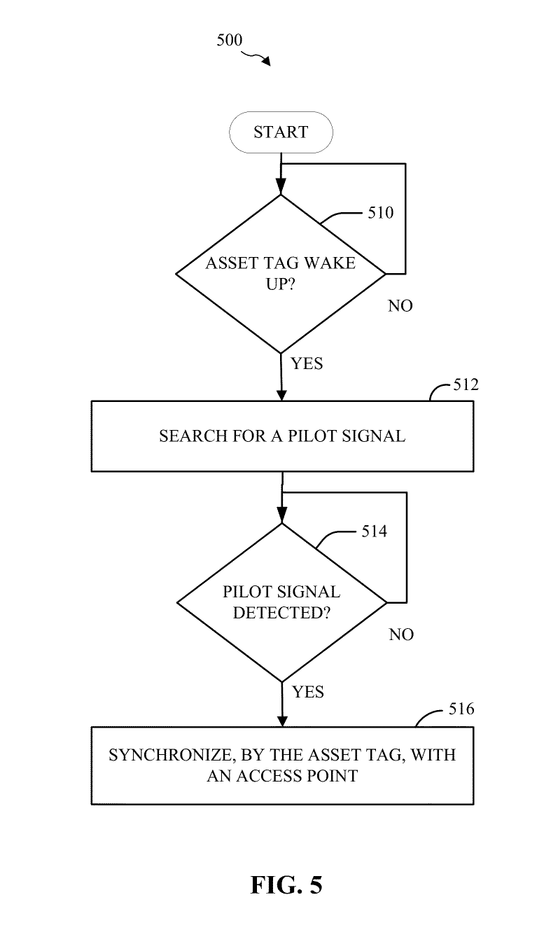

The controller/processor 240 may direct the operation at the access point 210 and the controller/processor 270 may direct the operation at wireless station 250, respectively. The controller/processor 270 and/or other processors and modules at the wireless station 250 may perform or direct the execution of the functional blocks illustrated in method flow charts of FIGS. 5, 6, 8 and 9 and/or other processes for the techniques described herein. The memory 242 may store data and program codes for the access point 210 and the memory 272 may store data and program codes for the wireless station 250. For example, the memory 272 of the wireless station 250 may store a position location module 292 which, when executed by the controller/processor 270, configures the wireless station 250 for operation within a position location system, for example, as shown in FIG. 4. Similarly, the memory 242 of the access point 210 may store a position location module 290 which, when executed by the controller/processor 240, configures the access point 210 for operation within the position location system shown in FIG. 4.

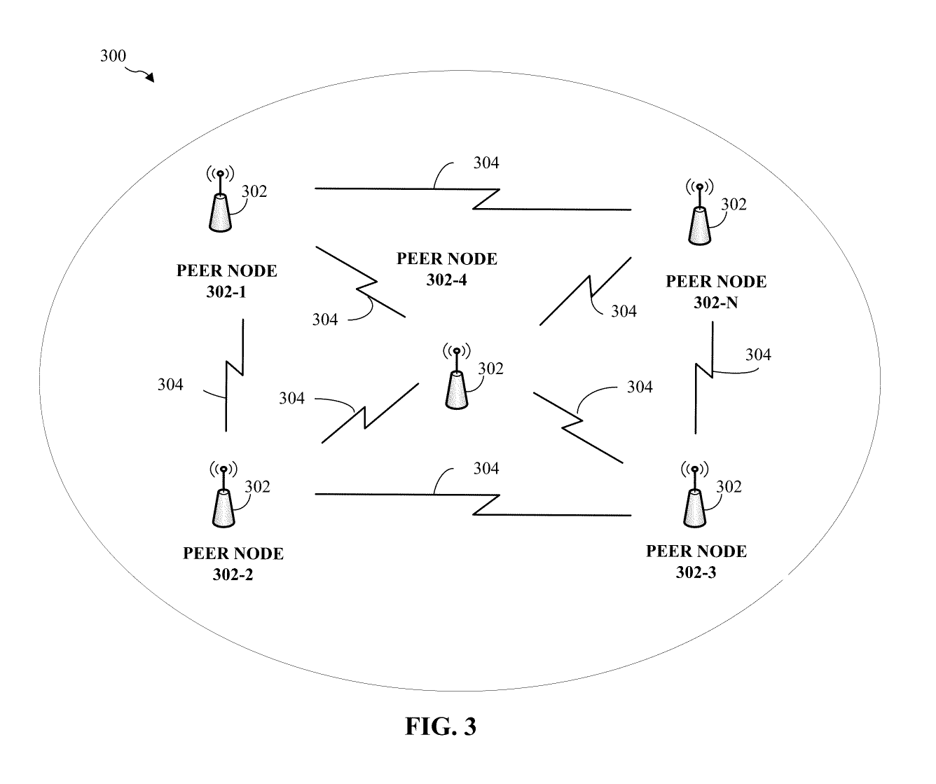

FIG. 3 illustrates a diagram of a peer-to-peer network 300 according to one aspect of the disclosure. In some aspects, a peer-to-peer network 300 may be established between two or more peer nodes 302 (302-1, 302-2, 302-3, 302-4, . . . 302-N). The peer nodes 302 in the peer-to-peer network 300 may communicate wirelessly using any suitable wireless network standard. The peer-to-peer network 300 may include a number of peer nodes 302 that can communicate with one another over wireless links 304. An asset tag may be configured according to the wireless station 250 of FIG. 2, and operate as one of the peer nodes 302 of the peer-to-peer network 300.

For example, an asset tag that operates as one of the peer nodes 302-1 may associate with another of the peer nodes 302-4 to transmit known preambles that are received by the peer nodes 302. One of the peer nodes 302-1 may estimate and send the time of arrival (TOA) of the preamble from a specific asset tag to a position location server (not shown) that estimates the position of the asset tags. Position location computations may be carried out at the position location server using the TOAs received from the different peer nodes 302. In another configuration, the peer nodes 302 transmit a known beacon signal, which is typically a wide bandwidth beacon signal, which is received by all asset tags in the respective coverage area of the peer nodes. In this configuration, the asset tags make TOA and/or TDOA measurements on the received beacon signals from different peer nodes 302 and either compute the position at the asset tag or send the measurements to the position location server for position location computation.

An asset tag may be any device configured to send and receive wireless communications, such as a laptop computer, a smartphone, a printer, a personal digital assistant, a camera, a cordless telephone, a session initiation protocol phone, a handheld device having wireless connection capability, a user equipment, an access terminal, or any other suitable device that may be worn as an asset tag.

FIG. 4 is a diagram illustrating a position location system 400 according to one aspect of the disclosure. The position location system 400 may track assets (e.g., people) using asset tags 402 (402-1, . . . , 402-N) that people wear. The asset tags 402 may be configured according to the wireless station 250 of FIG. 2 to support wireless node functionality (e.g., wireless stations and/or a wireless nodes of a peer-to-peer network), or other like radio access technology.

As shown in FIG. 4, the position location system 400 includes the asset tags 402, APs 403 installed on the premises, and a position location server 480 that estimates the position of the asset tags 402. In one configuration, the asset tags 402 transmit known preambles that are received by the APs 403. The APs 403 may estimate and send the time of arrival (TOA) of the preamble from a specific asset tag to the position location server 480. Position location computations may be carried out at the position location server 480 using the TOAs received from the different APs 403, or the estimation may be performed by some other estimator, within the AP 403 or at the position location server 480. This approach may help reduce the power consumption at the asset tags 402.

In another configuration, the APs 403 transmit a known beacon signal, which is received by all asset tags 402 in the respective coverage area of the APs 403. In this configuration, the asset tags 402 make TDOA measurements based on the received beacon signals (also referred to as “beacons”) from different APs 403. The asset tags 402 may either compute the position at one of the asset tags 402 or send the measurements to the position location server 480 for position location computation. In the configuration where the asset tags 402 measure the beacon signals from APs 403 and compute their respective position without the position location server 480, higher power consumption at the asset tags 402 may lower battery life.

The position location system 400 recognizes that the two basic functions of a tracking system, messaging and positioning, have different specifications. For messaging, one of the asset tags 402-1 communicates with one of the APs 403 (e.g., closest to the asset tag), in which a small amount of data is exchanged. As a result, bandwidth is not a primary concern in the messaging portion of the position location system 400. For positioning, ranging measurements may be made between asset tags 402 and multiple APs 403. As a result, the ranging operation may involve a longer access distance. Moreover, a wide bandwidth for a ranging signal is desired to achieve accurate range measurements. In one configuration, the position location system 400 provides the messaging and coarse synchronization portion of the air interface of the system architecture on a first air interface (messaging link) and the ranging portion of the system architecture on a second air interface (ranging link). For example, the position location server 480 may be configured as shown in FIG. 2, in which one of the antennas 234 provides a ranging link and a narrowband messaging link (NML) 220 provides a messaging link.

In one configuration, a narrowband messaging link (e.g., NML 220 of FIG. 2) is used for a messaging and synchronization to enable a subsequent ranging measurement. The narrowband messaging link 220 may be used by the asset tags 402 to communicate with APs 403 installed on the premises, as well as to provide coarse synchronization between the APs 403 and also between the APs 403 and the asset tags 402. In one configuration, the asset tags 402 wake up periodically and search for beacon signals transmitted by APs 403 on a relatively narrowband signal, such as one MHz of bandwidth using, for example the narrowband messaging link 220, versus many tens or hundreds of MHz of bandwidth for a ranging link. Once a coarse time synchronization is achieved, a ranging operation begins by exchanging preambles between the asset tags 402 and the access points 403.

FIG. 5 is a flow chart illustrating a position location initialization method 500 implemented in the position location system of FIG. 4. At block 510, the method begins by determining whether an asset tag is awake by detecting an asset tag wakeup. For example, as shown in FIG. 4, the asset tags 402 periodically wake up as part of a synchronization process. At block 512, the asset tag searches for a beacon signal. For example, the APs 403 periodically transmit a beacon signal for detection by the asset tags 402. At block 514, it is determined whether the asset tag detects the beacon signal. Once detected, the asset tag synchronizes with the access point that transmitted the beacon signal at block 516. In one configuration, the beacon signal includes a known preamble or a pseudo noise (PN) code as an access point identification field. In this configuration, the APs 403 send out the beacon signals to identify themselves. The APs 403 may not know which asset tag 402 is listening. Because there may be multiple of asset tags 402, an asset tag identification field (ID) may be included in the beacon signal.

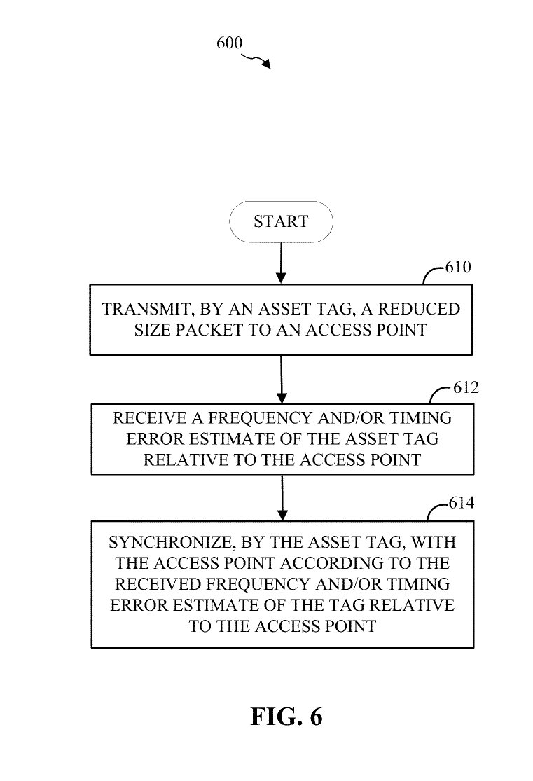

FIG. 6 is a flow chart illustrating a position location synchronization method 600 implemented in the position location system of FIG. 4. At block 610, an asset tag transmits a short packet to an AP. For example, as shown in FIG. 4, the asset tags 402 transmit a short packet to the APs 403 using a narrowband message link (e.g., the NML 220). At block 612, the asset tag receives a frequency and/or timing error estimate of the asset tag relative to the AP. At block 614, the asset tag synchronizes with the access point according to the received frequency and/or timing error estimate of the asset tag relative to the AP. Once synchronized, a ranging operation with the access point may be initiated. For example, as shown in FIG. 4, the ranging operation may be performed by the APs 403 and/or the position location server 480 to determine a location of one of the asset tags 402-1.

Synthetic Wideband Ranging

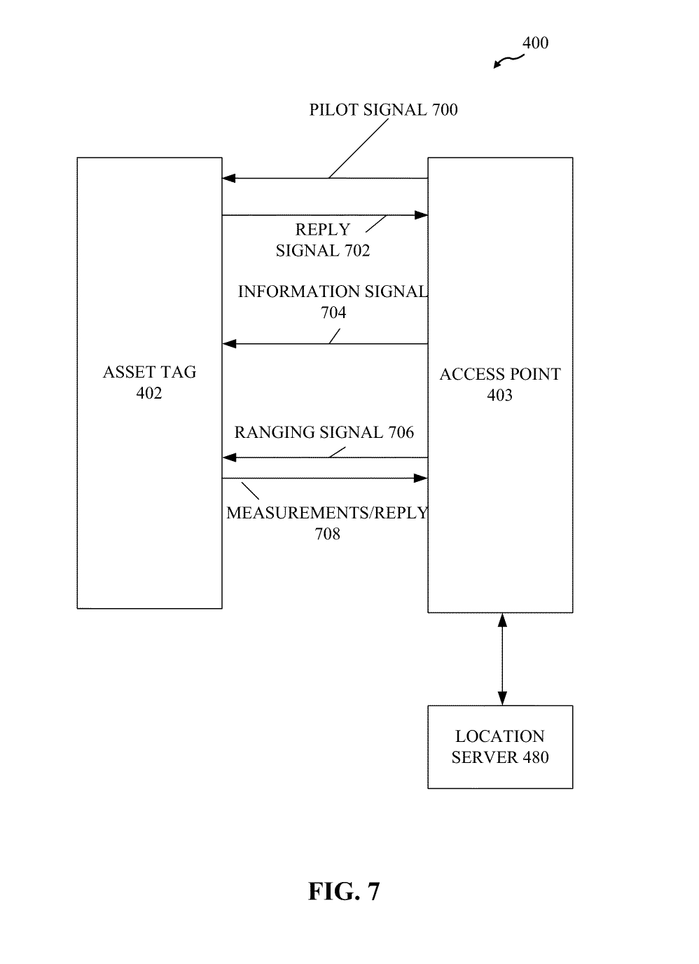

FIG. 7 is a block diagram illustrating a signaling diagram in accordance with one aspect of the present disclosure.

The position location system 400 as shown in FIG. 4 of the present disclosure may have asset tags 402 that are asleep within system 400. Initialization of the asset tags is described, at least in part, as discussed with respect to FIG. 5 of the present disclosure, and, for example, a beacon signal 700 is periodically sent from access point 403 in the position location system 400. Although the beacon signal 700 is sent periodically, the asset tag 402 may not be awake in the system 400, and thus, would not respond to the beacon signal 700. However, once the asset tag 402 is awake in the position location system 400, the asset tag 402 may send a reply signal 702 to the access point 403 such that the access point 403 is aware that a particular asset tag 402 is awake. The beacon signal 700 and reply signal 702 may be sent on a first link, such as a narrowband messaging link, if desired, or may be sent on a ranging link.

The access point 403 then may send the results of an initial ranging estimate based on the beacon signal 700 and the reply signal 702, and/or may send ranging information for the ranging signal(s) 706 to be transmitted from the access point 403, in the information signal 704.

One or more ranging signals 706 may then be sent from the access point 403 to the asset tag 402. Although described with respect to the access point 403, such a ranging signal may be sent as a peer-to-peer signal between the asset tags 402 if desired.

The bandwidth of the ranging signal 706 may be many tens of MHz, and, perhaps a few hundred MHz to allow range estimation for the asset tags 402 to achieve higher resolution. In one aspect of the present disclosure, a wideband ranging beacon signal can be synthesized by transmitting a narrowband ranging signal 706 a number of times in different frequency bands sequentially in time from the access point 403 to the asset tag 402. For example, and not by way of limitation on the present disclosure, an 80 MHz ranging signal 706 using an orthogonal frequency division modulation (OFDM) transmission schema can be used.

The ranging signal 706 may have a known pseudo noise (PN) code that may be spread on different tones of the OFDM signal. The ranging signal 706, (e.g., to continue with the present example, the 80 MHz signal), is transmitted starting at a known frequency location, and shortly after sending that ranging signal 706, another copy of the same ranging signal 706 is transmitted at a second known frequency location 80 MHz higher than the original frequency location. It can be seen that the frequency of the signal and the difference in frequency between the first known frequency location and the second known frequency location are independent parameters, and the second known frequency location can be lower than the first known frequency location, without departing from the scope of the present disclosure. Although the ranging signals 706 are described as being the same, in another configuration, they are different from each other and/or have different bandwidths.

To continue increasing the bandwidth of the overall ranging signal 706, the process can be repeated, by transmitting another copy of the ranging signal 706 at a third known frequency location, which may be 160 MHz higher than the first known frequency location. Again, the third known frequency location can be at any known location, however, by associating the frequency bandwidth of the ranging signal 706 and the total frequency bandwidth of the spectrum to be used for ranging the portions of ranging signal 706 can then be transmitted a certain number of times to cover most or all of the spectrum in sequential or some other known order.

Because in this example, the ranging signal 706 is transmitted using an OFDM transmission scheme, the channel frequency response on each tone of the OFDM signal is combined to achieve a channel impulse response measurement with increasing time resolution, as the ranging signal 706 is retransmitted across different spectra sequentially. To continue with the present example, if the 80 MHz ranging signal 706 is transmitted five times, starting at a first known frequency of 80 MHz and increasing the starting frequency by 80 MHz for each of the five transmissions, the relatively narrow bandwidth 80 MHz signal synthesizes to a 400 MHz wideband ranging signal. It should be noted that the re-transmission frequencies of these ranging signals may not be continuous in frequency. For example, an 80 MHz ranging signal 706 may be transmitted five times to cover a 1 GHz range, at 0, 200 MHz, 400 MHz, 600 MHz and 800 MHz with gaps between the ranging signals 706.

The initial frequency of the raging signal 706 can be selected to be at a specific frequency prior to the sequential transmission (i.e., the initial or the center frequency of the narrow bandwidth ranging signal 706 can be selected). So, for example, specific OFDM tones can be used initially, which may not be the lowest frequency OFDM tone, and the frequency or the tone frequency location may be changed in any direction, to utilize the characteristics of specific frequency ranges for the ranging signal 706. For example, an aspect of the present invention may select an OFDM tone or other frequency for the first narrowband signal transmission based on that frequency ranges' ability to penetrate structure walls, because that frequency spectra has known propagation characteristics, because that tone is typically not used by other communication links, and/or for other reasons.

The asset tag 402, having received the ranging signal starting frequencies and the ranging signal transmission times in the information signal 704, can then determine the receipt time of the various ranging signals 706 across the multiple transmissions of the ranging signal 706 throughout the synthesized bandwidth for the ranging operation of the position location system 400. The asset tag 402 then sends measurements and/or a reply signal 708 to the access point 403. Calculations or parameters in the information signal 704, the ranging signal 706, the beacon signal 700, or as a result of the reply signal 702 or the reply signal 708, can be performed by the access point 403 or can be transmitted to the position location server 480 by the access point 403.

Because the frequency range of each individual narrowband ranging signal 706 is lower, this aspect of the present disclosure provides a lower power and a and a lower complexity of the position location system 400 due to a lower sampling rate. Further, the position location system 400 of the present disclosure can be any system that allows for coherent combination of multiple narrowband signals. Although it is advantageous to transmit the narrowband signals sequentially in time, (e.g., a new signal every time period of the system 400), the ranging signals may be transmitted less often, or to increase the bandwidth of the narrowband signal being transmitted based on other factors such as gaps in the available spectrum, timing structures of surrounding systems, or other factors.

Further, the position location system 400 of the present disclosure does not specify a continuous spectrum to transmit the narrowband ranging signal. The known frequency locations may be at different places in the frequency spectrum, and may start at higher frequencies and move to lower frequencies, or may start at a central frequency and alternatively move up and down in known frequency location, as well as being discontinuous in frequency spectrum to better utilize the frequency spectrum available. Such an position location system 400 can also be designed to operate differently depending on geographic location, e.g., can be designed to operate in a first manner in one continent and another manner in a different continent, or in one manner in a first location and another manner in a second location, based on available spectrum, interfering signals from pre-existing systems, or other factors.

In one configuration, a position location system includes a means for transmitting a ranging signal a predetermined number of times in different frequency bands to form a wideband ranging signal. In one aspect of the disclosure, the transmitting means may be the transmit processor 214, controller/processor 240, memory 242, transmitters 232a-t, antennas 234a-234t, module 290 and/or other means configured to perform the functions recited by the transmitting means. In this configuration, the position location system also includes a means for estimating a range of a device in the position location system based on the wideband ranging signal. In one aspect of the disclosure, the estimating means may be the controller/processor 240 and/or other means configured to perform the functions recited by the estimating means. In another aspect, the aforementioned means may be any module or any apparatus configured to perform the functions recited by the aforementioned means.

In another configuration, a position location system includes means for storing samples from sequentially received signals, each signal being received in a different frequency band. In one aspect of the disclosure, the means for storing samples may be the memory 242 or other means configured to perform the functions recited by the storing means. In this configuration, the position location system also includes means for jointly processing the samples to form a single waveform. In one aspect of the disclosure, the means for jointly processing the samples may be the controller/processor 240, receive processor 238, or other means configured to perform the functions recited by the processing means. In this configuration, the position location system also includes means for estimating a range from the single waveform according to a predetermined ranging operation. In one aspect of the disclosure, the means for estimating may be the controller/processor 240, position location server 480, or other means configured to perform the functions recited by the estimating means.

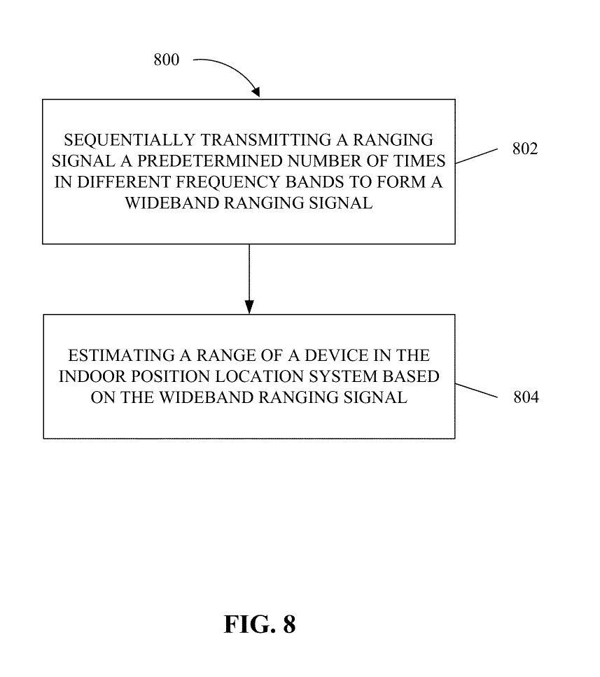

FIG. 8 is a flow chart illustrating a method 800 in accordance with an aspect of the present disclosure. At block 802 a ranging signal is sequentially transmitted a predetermined number of times in different frequency bands to form a wideband ranging signal. At block 804 a range of a device in the position location system is estimated based on the wideband ranging signal.

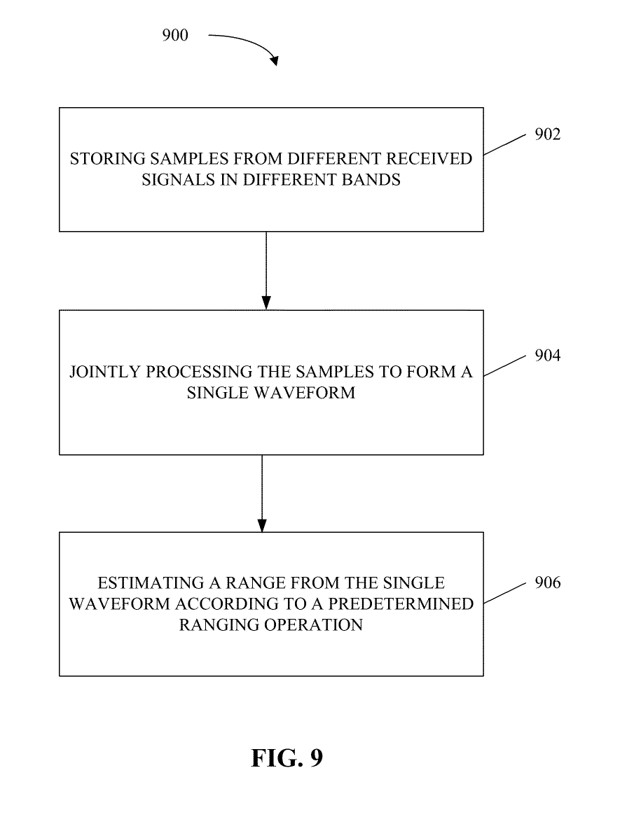

FIG. 9 is a flow chart illustrating a method 900 in accordance with another aspect of the present disclosure. At block 902 samples from different received signals in different bands are stored. At block 904 the samples are jointly processed to form a single waveform. At block 906 a range is estimated from the single waveform according to a predetermined ranging operation.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication within a position location system, comprising:
sequentially transmitting a ranging signal a predetermined number of times in different frequency bands to form a wideband ranging signal; and
receiving a range estimate based at least in part on the wideband ranging signal.

2. The method of claim 1, in which the different frequency bands are contiguous frequency bands.

3. The method of claim 1, in which the different frequency bands are non-contiguous frequency bands.

4. The method of claim 1, further comprising spreading a known pseudo noise (PN) code onto the wideband ranging signal.

5. The method of claim 1, in which the ranging signal is sequentially transmitted on different tones of an orthogonal frequency division multiplexed (OFDM) signal to form the wideband ranging signal.

6. The method of claim 1, in which at least one of the sequentially transmitted ranging signals is different from at least one other of the sequentially transmitted ranging signals.

7. A method of wireless communication within an position location system, comprising:
storing samples from sequentially received signals, each signal being received in a different frequency band;
jointly processing the samples to form a single waveform; and
estimating a range from the single waveform according to a predetermined ranging operation.

8. The method of claim 7, in which the single waveform comprises a wideband ranging beacon signal.

9. The method of claim 7, in which the different frequency band is a contiguous frequency band.

10. The method of claim 7, in which the different frequency band is a non-contiguous frequency band.

11. A position location system, comprising:
a transmitter configured to sequentially transmit a ranging signal a predetermined number of times in different frequency bands to form a wideband ranging signal; and
a receiver configured to receive a range estimate based at least in part on the wideband ranging signal.

12. The position location system of claim 11, in which the different frequency bands are contiguous frequency bands.

13. The position location system of claim 11, in which the different frequency bands are non-contiguous frequency bands.

14. The position location system of claim 11, in which the transmitter is further configured to spread a known pseudo noise (PN) code onto the wideband ranging signal.

15. The position location system of claim 11, in which the transmitter is further configured to sequentially transmit the ranging signal on different tones of an orthogonal frequency division multiplexed (OFDM) signal to form the wideband ranging signal.

16. The position location system of claim 11, in which at least one of the sequentially transmitted ranging signals is different from at least one other of the sequentially transmitted ranging signals.

17. A position location system, comprising:
means for sequentially transmitting a ranging signal a predetermined number of times in different frequency bands to form a wideband ranging signal; and
means for receiving a range estimate based at least in part on the wideband ranging signal.

18. The position location system of claim 17, in which the different frequency bands are contiguous frequency bands.

19. The position location system of claim 17, in which the transmitting means is for sequentially transmitting the ranging signal on different tones of an orthogonal frequency division multiplexed (OFDM) signal to form the wideband ranging signal.

20. A computer program product configured for wireless communication within an position location system, the computer program product comprising:
a non-transitory computer-readable medium having non-transitory program code recorded thereon, the non-transitory program code comprising:
program code to sequentially transmit a ranging signal a predetermined number of times in different frequency bands to form a wideband ranging signal; and
program code to receive a range estimate based at least in part on the wideband ranging signal.

21. A position location system, comprising:
means for storing samples from sequentially received signals, each signal being received in a different frequency band;
means for jointly processing the samples to form a single waveform; and
means for estimating a range from the single waveform according to a predetermined ranging operation.

22. A computer program product configured for wireless communication within an position location system, the computer program product comprising:
a non-transitory computer-readable medium having non-transitory program code recorded thereon, the non-transitory program code comprising:
program code to store samples from sequentially received signals, each signal being received in a different frequency band;
program code to jointly process the samples to form a single waveform; and
program code to estimate a range from the single waveform according to a predetermined ranging operation.

23. A position location system, comprising:
a memory configured to store samples from sequentially received signals, each signal being received in a different frequency band;
a processor coupled to the memory and configured to jointly process the samples to form a single waveform; and
an estimator coupled to the memory and configured to estimate a range from the single waveform according to a predetermined ranging operation.

24. The position location system of claim 23, in which the single waveform comprises a wideband ranging beacon signal.

25. The position location system of claim 23, in which the different frequency band is a contiguous frequency band.

26. The position location system of claim 23, in which the different frequency band is a non-contiguous frequency band.
